(19) United States
(12) Patent Application Publication
(10) Pub. No.: US 2009/0010248 A1
(43) Pub. Date: Jan. 8, 2009

(54) Data Communication System and Data Communication Method

(76) Inventor: Takeo Kanai, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/817,089

(22) PCT Filed: Feb. 23, 2006
(86) PCT No.: PCT/JP2006/303303

§ 371 Date: Feb. 26, 2008

(51) Int. Cl. H04L 12/66

(52) U.S. Cl. 370/352

(57) ABSTRACT

An IP terminal 1 at a transmitting end has a copying unit 111 for copying packet data to be transmitted; an address setting unit 112 for adding unique address information to the respective copied packet data having the same contents; and a transmitting unit 113 for outputting, based on the address information, the copied packet data to different paths 1, 2 on an IP network 3. An IP terminal 5 has a selecting unit 523 for selecting and acquiring the first arriving packet data of the copied packet data having the same contents. In this way, for a data communication in a communication network such as Internet, a plurality of communication paths are used in a packet network, thereby reducing packet jitter and loss at the receiving end and providing a real time service having substantially the same quality as in a line exchanging network.

### TECHNICAL FIELD

The present invention relates to a data communication system and a data communication method for transmitting and receiving packet data, that is, IP packetized audio data of a real time service, for example, an IP telephone service through a communication network such as the Internet constructed by connecting communication lines with each other.

### BACKGROUND ART

In recent years, data communication through a communication network such as the Internet constructed by connecting communication lines with each other has been developed. This type of data communication employs a packet communication system in which the data to be transmitted and received is divided into IP packet data items which are transmitted and received one after another. This IP packet data includes payload data, and additional information such as the address of the destination, the positional information indicative of the location of the packet in the entirety of the data, error correction code, and other control information. Meanwhile, this packet communication is performed by a variable-length packet method in which the amount of data per packet is variable in a predetermined range or a fixed-length packet method in which the amount of data per packet (cell) is fixed for example at 53 bytes in the case of ATM or the like.

By utilizing this type of packet communication, it is possible to prevent communication between two points from occupying an intermediate communication pathway (line) and make effective use of the communication line. In addition, since paths can be flexibly selected, there is an advantage in that even when a failure occurs in some communication line, another communication line can substitute for the failure.

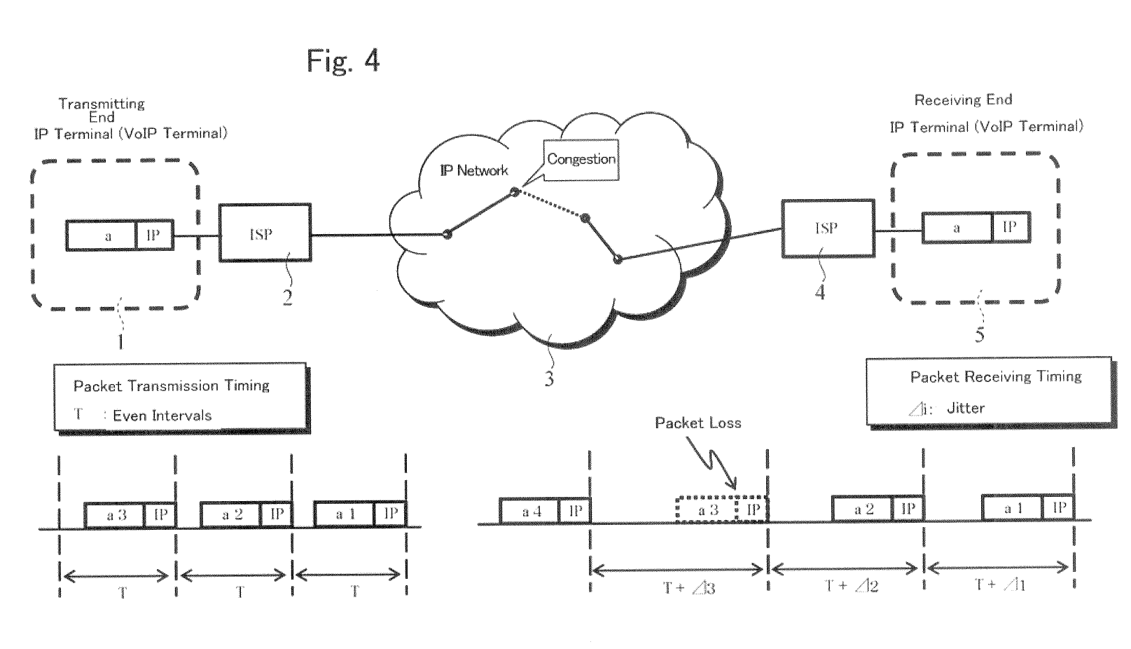

Contrary to this, in accordance with the IP packet communication described above, although paths can be flexibly selected as has been discussed above, the so-called congestion may sometimes occurs as illustrated in FIG. 4 where a large number of IP packets are concentrated to one communication line. When this congestion occurs, there may arise problems such as data delay (jitter) or packet loss.

Particularly, in the case of the Internet telephony or the like in which sound is IP packetized, unlike audio data handled through circuit switching, audio data items (packets) do not arrive at the destination codec at even time intervals, and thereby a buffer is needed to absorb jitter resulting in an increased delay time corresponding to the buffer. In addition to this, if jitter grows, it may no longer be absorbed by the buffer resulting in packet loss (audio data frame loss) to substantially degrade the quality of the reproduced sound output from the codec.

Patent Document 1 discloses the technique for solving or avoiding the congestion of packet data as described above. In the case of the technique disclosed in this Patent Document 1, at each of the respective elements (nodes) constituting a communication network, a delay circuit is provided for delaying the signal received of the input port corresponding to the delay times at the respective elements (nodes). Then, a path having the shortest delay is searched for by determining the earliest output signal among the signals which are output from the delay circuits of the output ports of the respective elements and returned to the input ports through the network.

However, in the case of the technique disclosed in the Patent Document 1 as described above, a delay circuit has to be provided at each node on the communication network such that the equipment expense may become enormous. In addition to this, in the case of the technique disclosed in this Patent Document 1, the delay time of the signal output from an output port and returned through the communication network is determined on the basis of the detection result at the delay circuit of each node so that there is a problem that the detection of the delay time cannot be performed on a real time base. Particularly, more adequate real time processing is required for a real time service such as an IP telephone service which transmits and receives IP packetized audio data via a global communication network such as the Internet in which congestion is continuously and instantaneously changing.

Patent Document 1: Japanese Patent Published Application No. Hei 5-14344

### SUMMARY OF THE INVENTION

Taking into consideration the above circumstances, it is an object of the present invention to provide a data communication system and a data communication method in which for a data communication in a communication network such as Internet, a plurality of communication paths are used in the communication network, thereby reducing packet jitter and loss at the receiving end, and providing a real time service having substantially the same quality as in a line exchanging network such as an IP telephone service which transmits and receives IP packetized audio data.

In order to accomplish the object as described above, the present invention is related to a data communication system operable to transmit and receive a packet data item through an IP network constructed by connecting communication lines with each other, the data communication system comprising: a copying unit operable to copy the packet data item to be transmitted at a transmitting terminal end; an address setting unit operable to allocate a unique address information to each of the copies of the packet data item having the same content; a transmitting unit operable to transmit the copies of the packet data item to different paths on the communication network on the basis of the address information; and a selecting unit operable to select and acquire a first arriving packet data item from among the copies of the packet data item having the same content at a receiving terminal end.

On the other hand, the other invention is related to a data communication method of transmitting and receiving a packet data item through an IP network constructed by connecting communication lines with each other, comprising: the steps of copying the packet data item to be transmitted at a transmitting terminal end; allocating a unique address information to each of the copies of the packet data item having the same content; transmitting the copies of the packet data item to different paths on the communication network on the basis of the address information; and selecting and acquiring a first arriving packet data item from among the copies of the packet data item having the same content at a receiving terminal end.

In accordance with these inventions, one packet is copied at the transmission end to prepare a plurality of copy packets which are transmitted to the different paths respectively, and thereby the packet data items having the same content can be forwarded through communication paths having different delay times. Then, in accordance with the present invention, since the first arriving packet data item is selected at the receiving end, it is possible to select a communication path having a smaller amount of delay without preparing a complicated measuring means located on the communication network.

In accordance with the above invention, it is preferred to trace said different communication paths; and perform route change when it is determined on the basis of the tracing result that the different communication paths overlap. In this case, when a plurality of paths selected as different paths partially or entirely overlap and eventually become the same path, it is possible to replace, for example, the path which was not selected, and search for another communication path to select another communication path having a smaller amount of delay.

In accordance with the invention, it is preferred to periodically perform path tracing. In this case, by periodically performing re-tracing, it is possible to update the communication paths and select more effective communication paths. Meanwhile, the re-tracing of paths may be more flexibly performed, i.e., not only periodically performed but also performed when the delay time is greater than or equal to a predetermined amount, when the differential delay time between a plurality of communication paths is less than or equal to a predetermined amount, and so forth.

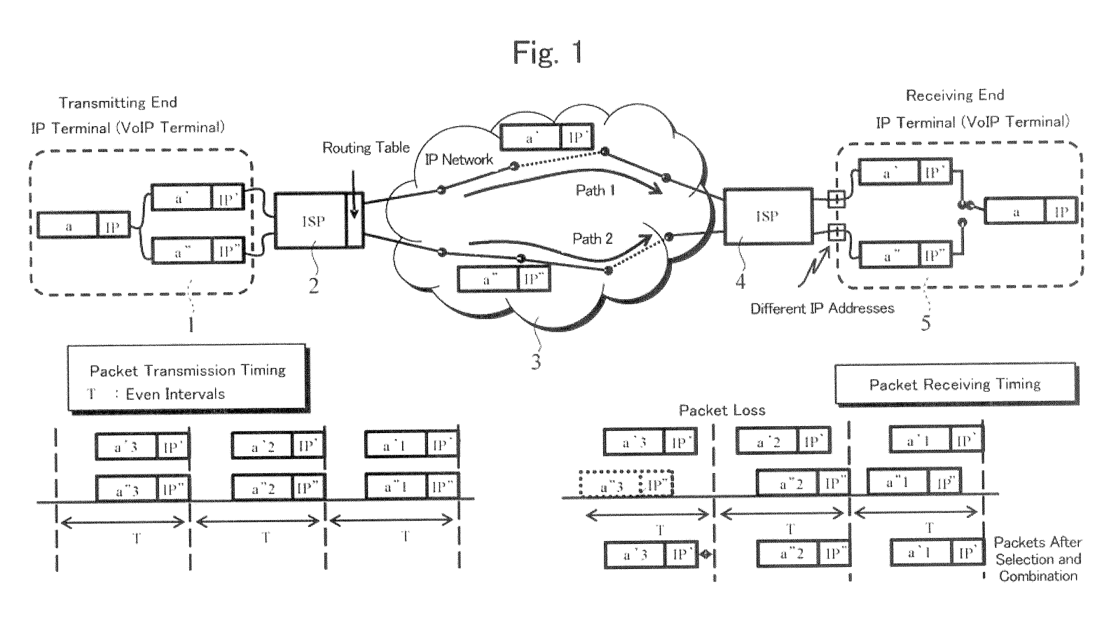

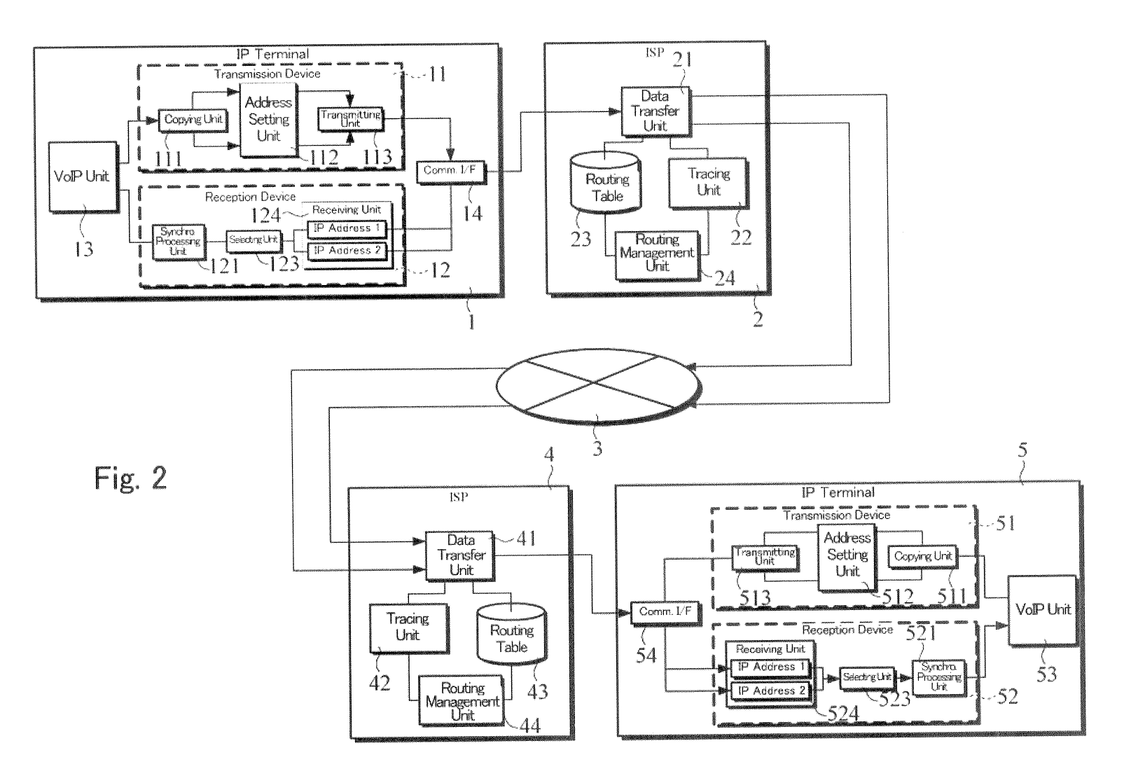

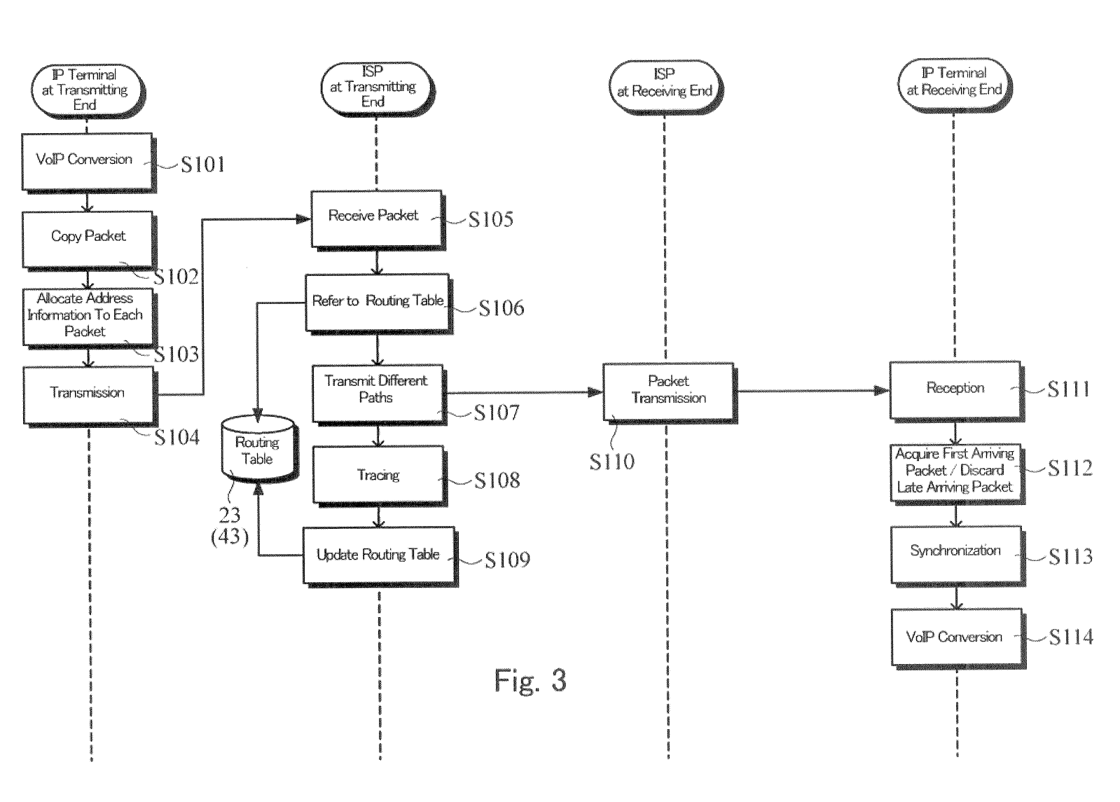

### BRIEF DESCRIPTION OF THE DRAWINGS

[FIG. 1] A view for schematically showing the configuration of a data communication system in accordance with an embodiment.

[FIG. 2] A block diagram for showing the internal structures of the IP terminals 1 and 5 and the ISPs 2 and 4 in accordance with the embodiment.

[FIG. 3] A sequence diagram for showing the operation of the data communication system in accordance with the embodiment.

[FIG. 4] A view for schematically showing the configuration of a data communication system in accordance with a prior art.

### BEST MODE FOR CARRYING OUT THE INVENTION

An embodiment of the present invention will be explained with reference to the accompanying drawings. FIG. 1 is a view for schematically showing the configuration of a data communication system in accordance with the present embodiment.

As shown in the same figure, the data communication system in accordance with the present embodiment includes IP terminals (VoIP terminals) 1 and 5 which can communicate with each other through ISPs (Internet Services Providers) 2 and 4 located on the IP network 3 in both directions. The IP network 3 is a distributed communication network, like the Internet, which is constructed by connecting a variety of communication lines (a telephone line, an ISDN line, a public network such as an ADSL line, a dedicated communication line, and a radio communication network) to each other by the use of the communication protocol TCP/IP. This IP network 3 may be a LAN such as an intranet (a network within a company) based on 10BASE-T, 100BASE-TX or the like. Each of the IP terminals 1 and 5 is an arithmetic operation unit provided with a CPU and can be implemented by a general purpose computer, for example, a personal computer, or a dedicated device having specific capabilities, inclusive of a mobile computer, a PDA (Personal Digital Assistance) and a cellular phone. Particularly, these IP terminals 1 and 5 are provided with the so-called VoIP capabilities for transmitting and receiving audio data as IP packet data through the IP network 3 to enable telephone conversation.

Each of the ISPs 2 and 4 is a server unit or server unit group managed by an Internet service provider for connecting clients such as company and home computers with the IP network 3 through telephone lines, ISDN networks, dedicated data communication lines and the like. In the case of the present embodiment, these ISPs 2 and 4 are provided with the capabilities of the call agent server of the so-called IP telephony terminal, and operates as a call control device, when providing an IP telephone service on the IP network 3, such that the IP network 3 is used as a transit switch for packet data.

Then, in accordance with the data communication system of the present embodiment as described above, when performing the transmission and reception of packet data between the IP terminals 1 and 5, the IP terminal 1 at the transmission end copies a packet data item a to be transmitted as copy packet data items a′ and a″, transmits these copy packet data items a′ and a″ to separate paths (path 1 and path 2) on the IP network 3, and the IP terminal 5 at the receiving end selects and acquires the first arriving packet data item from among the packet data items containing the same content as received. In what follows, more specific configuration will be explained.

(Configuration of IP Terminal and ISP)

FIG. 2 is a block diagram for showing the internal structures of the IP terminals 1 and 5 and the ISPs 2 and 4 in accordance with the present embodiment. Meanwhile, the IP terminals 1 and 5 have the same structure and are provided with both transmission and reception devices respectively. The ISPs 2 and 4 have also the same structure but, in this explanatory example, data is transmitted from the IP terminal 1 to the IP terminal 5 while the respective devices will be explained with reference symbols which are different between the transmission end and the receiving end for the sake of clarity in explanation.

The IP terminal 1 at the transmission end is provided with a VoIP unit 13 for implementing a voice conversation capability by performing the interconversion between audio data and packet data, a transmission device 11, a reception device 12 and a communication interface 14 for transmitting and receiving data.

The communication interface 14 is a device or software capable of connecting the IP terminal 1 with the IP network 3, and includes a modulator demodulator device such as a modem for converting digital data into an audio signal and vice versa when connecting with a telephone line, a signal conversion device such as an ADSL modem for converting an ADSL signal into a LAN signal and vice versa when connecting with an ADSL line, and a terminal equipment such as a DSU or a terminal adapter which is required for connecting with an ISDN line.

The transmission device 11 is provided with a copying unit 111 for copying packet data to be transmitted at the transmitting terminal end, an address setting unit 112 for allocating unique address information to each copy of the packet data item having the same content, and a transmitting unit 113 for transmitting copies of the packet data item to the ISP 2 through the communication interface 14.

The copying unit 111 is a module for copying the content (payload data a) of a packet data item, which is input from the VoIP unit 13, as it is as copy packet data items a′ and a″, and input these data copies to the address setting unit 112 respectively as separate data items after adding headers IP′ and IP″.

The address setting unit 112 is a module for writing, to the headers of the copy data items having the same content, the IP addresses of the caller and callee and the information indicating that the copy data items (a′ and a″) have the same content. The IP addresses of the callee are the IP addresses 1 and 2 allocated to the respective communication ports of the receiving unit 524 of the terminal at the receiving end. The transmitting unit 113 serves to successively transmit the copies of the packets to the ISP 2 through the communication interface 14.

The reception device 12 is provided with a receiving unit 124 for receiving packet data through the communication interface 14, a selecting unit 123 for selecting and acquiring the first arriving packet data item from among the copy packet data items having the same content, and a synchronization processing unit 121 for recovering original data from the packet data items as received.

The receiving unit 124 is provided with communication ports to which different IP addresses 1 and 2 are allocated, and capable of receiving packet data items having the same content through different paths respectively.

The selecting unit 123 is a module for parsing the headers of the packet data items received by the receiving unit 124, inputting the first arriving packet data item of the packet data items having the same content to the subsequent synchronization processing unit 121, and discarding the late arriving packet data item. More specifically speaking, if the packet data item as received contains data which is not yet received, it is transmitted to the synchronization processing unit 121 as it is, but if the packet data item as received contains data which has been already received, it is discarded without transmission to the subsequent stage.

The synchronization processing unit 121 is a module for rearranging the packet data items acquired through the selecting unit 123 in order to combine them and recover the original data, and inputting it to the VoIP unit 13. In addition, for example when the packet data is incomplete, the synchronization processing unit 121 performs an error correction process, sends a retransmission request to the transmission end, and so forth.

The ISP 2 at the transmission end is provided with a data transfer unit 21, a routing table 23, a tracing unit 22 and a routing management unit 24.

The data transfer unit 21 is a transmitting unit for transmitting packet data to different paths on the IP network 3 with reference to a routing table 23 on the basis of the address information allocated to the respective packet data items. The routing table 23 contains table data in which transfer paths on the IP network 3 are described, and the addresses of the next nodes are stored in correspondence with the callee.

the tracing unit 22 is a module for periodically tracing the routing actually performed by the data transfer unit 21 in regard to the two paths, and serves to monitor whether or not the routings of the two different paths 1 and 2 partially or entirely overlap and notify the result to the routing management unit 24. Incidentally, the tracing unit 22 according to the present embodiment serves to measure the response speeds of the respective nodes, the communication loads on the respective nodes, when performing the tracing, and notify the routing management unit 24 of the measurement.

The routing management unit 24 is a module for changing, if the different paths overlap, either path to another path on the basis of the tracing result of the tracing unit 22. More specifically speaking, the routing management unit 24 detects a path (which may be a path having a larger communication delay) which was not selected by the receiving unit at the receiving end, and make an attempt to replace this path which was not selected.

Meanwhile, the routing management unit 24 according to the present embodiment is provided with the functionality of taking into consideration the trade-off between the advantage of changing the path and the response speeds measured by the tracing unit 22, and even when the paths 1 and 2 partially overlap, while it is determined whether or not the communication speeds (communication loads) are close to each other, the path is not changed if the closeness is greater than or equal to a predetermined threshold. On the other hand, even when the paths 1 and 2 do not overlap at all, if the communication speeds are close to each other, the routing management unit 24 instructs that the path is to be changed for searching for a path providing a lighter load.

The IP terminal 5 at the receiving end has the similar configuration as the IP terminal 1 at the transmission end as described above, and is provided with a VoIP unit 53, a transmission device 51, a reception device 52 and a communication interface 54 which are similar as the respective modules as described above. The transmission device 51 is provided with a copying unit 511, an address setting unit 512 and a transmitting unit 513, in the same manner as described above, and the reception device 52 is provided with a receiving unit 524, a selecting unit 523, and a synchronization processing unit 521.

Also, the ISP 4 at the receiving end has the similar configuration as the ISP 2 at the transmission end as described above, and is provided with a data transfer unit 41, a routing table 43, a tracing unit 42 and a routing management unit 44 which are similar as the respective modules as described above.

(Data Communication Method)

The data communication method according to the present invention can be implemented by operating the data communication system having the structure as described above. FIG. 3 is a sequence diagram for showing the operation of the data communication system in accordance with the present embodiment. In this description, an example will be explained in the case where data is transmitted from the IP terminal 1 to the IP terminal 5. However, needless to say, the explanation is true also in the case where data is transmitted from the IP terminal 5 to the IP terminal 1.

As shown in the same figure, first, audio data is input through the IP terminal 1 at the transmission end, and this audio data is converted into IP packet data items a1 to a3 and input to the copying unit 111 in step S101. The copying unit 111 copies the packet data items to prepare a plurality of copies a′1 to a′3 and a″1 to a″3 having the same content in step S102, and write, to the headers IP′ and IP″ of the copies of each packet data item, the address information on a plurality of IP addresses 1 and 2 allocated to the receiving unit 524 of the IP terminal 5 at the receiving end and the information indicating that the copy data items have the same content in step S103. The transmitting unit 113 transmits these packet data items to the ISP 2 through the communication interface 14 in step S104.

The ISP 2 at the transmission end reads the header of each packet data item as received in step S105, determines the routing of the paths 1 and 2 for the different IP addresses 1 and 2 respectively with reference to the routing table 23 in step S106, and performs transmission in step S107. The respective packets which are transmitted arrive at the ISP 4 at the receiving end via the different paths 1 and 2 and are transferred to the IP terminal 5 at the receiving end by this ISP 4 in step S110.

The IP terminal 5 at the receiving end receives the packet data items having the same content at the IP addresses 1 and 2 allocated to the receiving unit 524 respectively in step S110. Then, the selecting unit 523 acquires the first arriving packet from among the packets having the same content and discards the late arriving packet data item in step S112. In the case of the example shown in FIG. 1, a′3 and a″2 and a′1 are acquired and combined.

Thereafter, the synchronization processing unit 521 performs the rearrangement and error correction of data to restore the original data, which is then input to the VoIP unit 53 in step S113. The VoIP unit 53 then converts the packet data into the audio data, which is output in step S114.

(Actions/Effects)

In accordance with the present embodiment as has been discussed above, the IP terminal 1 at the transmission end copies one packet to prepare a plurality of copy packets which are transmitted to the different paths 1 and 2, and thereby the packet data items having the same content can be forwarded through communication paths having different delay times (communication loads).

Then, since the IP terminal 5 at the receiving end selects the first arriving packet data item, it is possible to select a communication path having a smaller amount of delay without preparing a complicated measuring means located on the communication network.

In accordance with the above invention, the tracing unit 22 or 42 traces the different paths 1 and 2, and if it is determined on the basis of the tracing result that the paths 1 and 2 overlap, the path that is not selected at the receiving end is changed. Therefore, when a plurality of paths selected as different paths have eventually become the same path, it is possible to select another communication path having a smaller amount of delay.

### INDUSTRIAL APPLICABILITY

As has been discussed above, in accordance with the present invention, for a data communication in a communication network such as Internet, a plurality of communication paths are used in a packet network, thereby avoiding data congestion on a real time base, reducing packet jitter and loss at the receiving end, improving the reliability of communication and providing a real time service having substantially the same quality as in a line exchanging network such as an IP telephone service which transmits and receives IP packetized audio data.

What is claimed is:

1. A data communication system operable to transmit and receive a packet data item through an IP network constructed by connecting communication lines with each other, said data communication system comprising:
a copying unit operable to copy said packet data item to be transmitted at a transmitting terminal end;
an address setting unit operable to allocate a unique address information to each of the copies of the packet data item having the same content;
a transmitting unit operable to transmit said copies of the packet data item to different paths on said communication network on the basis of said address information; and
a selecting unit operable to select and acquire a first arriving packet data item from among said copies of the packet data item having the same content at a receiving terminal end.

2. The data communication system as claimed in claim 1 further comprising a tracing unit operable to trace said different communication paths; and a route management unit operable to perform route change when it is determined on the basis of the tracing result obtained by said tracing unit that said different communication paths overlap.

3. The data communication system as claimed in claim 2 wherein said route management unit controls said tracing unit to periodically perform tracing.

4. A data communication method of transmitting and receiving a packet data item through an IP network constructed by connecting communication lines with each other, said data communication method comprising:
a step (1) of copying said packet data item to be transmitted at a transmitting terminal end, and allocating a unique address information to each of the copies of the packet data item having the same content;
a step (2) of transmitting said copies of the packet data item to different paths on said communication network on the basis of said address information; and
a step (3) of selecting and acquiring a first arriving packet data item from among said copies of the packet data item having the same content at a receiving terminal end.

5. The data communication method as claimed in claim 4 further comprising a step of tracing said different communication paths, and performing route change when it is determined on the basis of the tracing result that said different communication paths overlap.

6. The data communication method as claimed in claim 5 wherein said path tracing is periodically performed.
